(19) United States
(12) Patent Application Publication
(10) Pub. No.: US 2011/0007394 A1
(43) Pub. Date: Jan. 13, 2011

(54) ANTI-FOG INSTRUMENT FOR SWIMMING GOGGLES

(76) Inventor: Ki-Suk Song, Gongju-Si (KR)

Correspondence Address: MAXON IP LLC, 46175 WESTLAKE DR., SUITE 410, POTOMAC FALLS, VA, 20165, US

(21) Appl. No.: 12/919,480

(22) PCT Filed: Mar. 4, 2009
(86) PCT No.: PCT/KR2009/001063

§ 371 Date: Aug. 25, 2010

(30) Foreign Application Priority Data
Mar. 11, 2008 (KR) 10-2008-0022537
Apr. 15, 2008 (KR) 10-2008-0004935

(51) Int. Cl. B60R 1/06

(52) U.S. Cl. 359/507

(57) ABSTRACT

The present invention provides an anti-fog instrument for swimming goggles including: a main body (10) that is made of a transparent synthetic resin to have a shape corresponding to a see-through window of the swimming goggles; an anti-fog layer (20) that is formed at the opposite side of the see-through window of the main body (10), by coating a material having an anti-fog function; an adhesive layer (30) that is formed at a side-facing the see-through window of the main body (10), by coating an adhesive material; a release paper (40) that is attached to the surface of the adhesive layer (30) to be easily detached; and a grip (50) that integrally protrudes from one side of the edge of the main body (10), in order to be replaced at any time while preventing fog when an anti-fog agent is not coated on a see-through window.

### TECHNICAL FIELD

The present invention relates to an anti-fog instrument for swimming goggles. More particularly, the present invention relates to an anti-fog instrument for swimming goggles that prevents the inner surface of the see-through windows of the swimming goggles from being fogged and can be easily replaced with a simple structure, thereby reducing the manufacturing cost and expense.

### BACKGROUND ART

In general, swimming goggles are worn to prevent water from coming into the eyes while allowing the eyes to be open when swimming or in water, which are commonly formed in a binocular type by providing one see-through window for each of both eyes.

Swimming goggles are composed of a pair of frames that are low around the nose and high around the ears, taking the shapes around the eyes on the face, and having see-through windows disposed on the front sides of the frames, packing members that are provided at the edges (edges of rear surfaces) of the frames contacting the face and to prevent water from coming into the eyes, a bridge connecting the pair of frames on the nose, and a band that connects the pair of frames around the ears and maintains the worn goggles by wrapping around the back of the head.

In the above configuration, the see-through windows and the bridge are integrally formed with the frames, or are individually formed and then assembled.

When swimming or in water with the swimming goggles having the above configuration, the inner surfaces of the see-through windows become fogged by a temperature difference between the inside and the outside thereof. That is, the outer surfaces of the see-through windows decrease in temperature by contacting the water, whereas the insides of the see-through windows are sealed spaces and increase in temperature by body heat, such that the inner surfaces of the see-through windows inevitably become fogged.

As the inner surfaces of the see-through windows are fogged or moisture forms thereon, the view is blurred or obstructed; therefore, the fog or moisture on the inner surfaces of the see-through windows needs to be removed after taking off the swimming goggles and then they are put back on. This needs to be frequently repeated and is very inconvenient.

Many swimming goggles coated with an anti-fog agent on inner surfaces of the see-through windows have been recently developed and provided.

However, according to swimming goggles coated with an anti-fog agent on the inner surfaces of the see-through windows, the coated anti-fog agent is partially removed by rubbing the see-through windows to remove moisture on the inner surfaces of the see-through windows or when water repeatedly sticks to the see-through windows and dries. Accordingly, as the coating is partially removed, the anti-fog function is rapidly deteriorated on the see-through windows. Therefore, the function of the anti-fog agent coated on the inner surfaces of the see-through windows disappears in a short time, and the user has to apply an anti-fog agent almost every day after the anti-fog agent coated in manufacturing has been removed. Further, a white phenomenon in which the see-through windows become partially white by a chemical action between the anti-fog agent and the material of the see-through windows appears, and the life of the swimming goggles is reduced.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide an anti-fog instrument for swimming goggles having an advantage that it can be replaced at any time by a material having an anti-fog function to prevent fog, when an anti-fog agent is not coated on a see-through window.

### Technical Solution

An anti-fog instrument for swimming goggles that is proposed by the present invention includes: a main body that is made of a transparent synthetic resin to have a shape corresponding to a see-through window of the swimming goggle; an anti-fog layer that is formed at the opposite side of the see-through window of the main body, by coating a material having an anti-fog function; an adhesive layer that is formed at a side facing the see-through window of the main body, by coating an adhesive material; a release paper that is attached to the surface of the adhesive layer to be easily detached; and a grip that integrally protrudes from one side of the edge of the main body.

The grip may be formed with a smaller length than the height of the frame of the swimming goggles, or with a larger length than the height of the frame of the swimming goggles to cover the edge of the frame.

The grip may be formed at only one position or at two to eight positions.

The anti-fog instrument for swimming goggles of the present invention may further include a protection layer provided on the anti-fog layer to prevent the anti-fog layer from being damaged or contaminated in manufacture, transport, and installation.

### Advantageous Effects

According to the anti-fog instrument for swimming goggles of the present invention, it is possible to easily replace the anti-fog instrument at any time because it is possible to finish installation of the anti-fog instrument by bonding from the end of one edge to the see-through window of the swimming goggles, after separating the release paper, and to separate the anti-fog instrument from the see-through window by detaching it while holding the grip.

According to the anti-fog instrument for swimming goggles of the present invention, it is possible to ensure sufficiently long durability of the anti-fog layer, as compared with when a user directly applies an anti-fog agent onto the see-through window in the related art, such that inconvenience is avoided and it is very efficient. For example, a user should repeat coating almost every day when directly applying an anti-fog instrument for goggles to the see-through window in the related art; however, according to the present invention, it is possible to maintain a sufficient anti-fog function even though the anti-fog instrument is used more than 30 days, thereby increasing the user's convenience.

Further, according to the anti-fog instrument for swimming goggles of the present invention, since the grip is formed and the protection film is provided, it is possible to prevent the anti-fog layer from being damaged or contaminated while it is transported or attached to the see-through window.

Further, according to the anti-fog instrument for swimming goggles of the present invention, since it is possible to prevent fogging even though a specific anti-fog agent is not applied to the see-through window, it is possible to prevent a white phenomenon that appears by a chemical reaction between the anti-fog agent and the material of the see-through window, and considerably increases the durability of the swimming goggles.

### BRIEF DESCRIPTION OF DRAWINGS

FIG. 1 is a perspective view showing a first exemplary embodiment of an anti-fog instrument for swimming goggles according to the present invention.

FIG. 2 is a cross-sectional view showing the first exemplary embodiment of an anti-fog instrument for swimming goggles according to the present invention.

FIG. 3 is a perspective view showing a pair of swimming goggles equipped with the first exemplary embodiment of an anti-fog instrument for swimming goggles according to the present invention.

FIG. 4 is a cross-sectional view illustrating a process of attaching the first exemplary embodiment of an anti-fog instrument for swimming goggles according to the present invention to a see-through window of a pair of swimming goggles.

FIG. 5 is a perspective view showing a second exemplary embodiment of an anti-fog instrument for swimming goggles according to the present invention.

FIG. 6 is a cross-sectional view illustrating when the second exemplary embodiment of an anti-fog instrument for swimming goggles according to the present invention is attached to a see-through window of a pair of swimming goggles.

FIG. 7 is a perspective view showing a third exemplary embodiment of an anti-fog instrument for swimming goggles according to the present invention.

FIG. 8 is a cross-sectional view illustrating when the third exemplary embodiment of an anti-fog instrument for swimming goggles according the present invention is attached to a see-through window of a pair of swimming goggles.

FIG. 9 is a perspective view showing a fourth exemplary embodiment of an anti-fog instrument for swimming goggles according to the present invention.

### BEST MODE FOR CARRYING OUT THE INVENTION

Preferred exemplary embodiments of the present invention are described hereafter in detail with reference to the accompanying drawings.

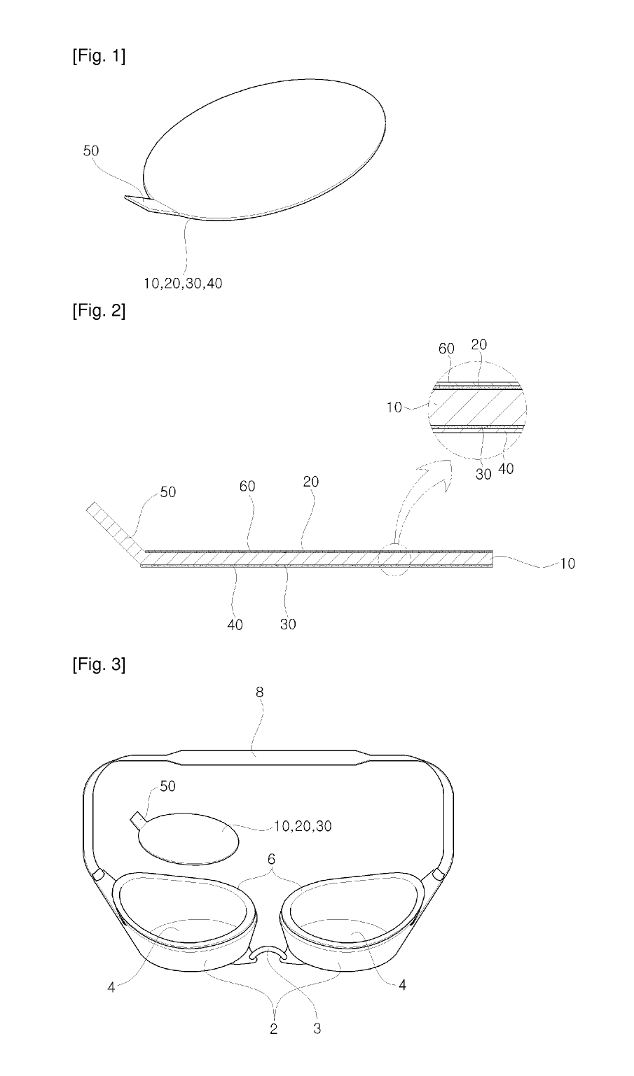

First, a first exemplary embodiment of an anti-fog instrument for swimming goggles according to the present invention, as shown in FIG. 1 to FIG. 3, includes a main body 10, an anti-fog layer 20, an adhesive layer 30, a release paper 40, and a grip 50.

A pair of swimming goggles to which the first exemplary embodiment of an anti-fog instrument for swimming goggles according to the present invention is applied, as shown in FIG. 3, includes a pair of frames 2, see-through windows 4 that are disposed at the front sides (opposite to the face) of the frames 2, packing members 6 that are disposed at the rear sides (the sides contacting the face) of the frame to prevent water from permeating inside, a bridge 3 that connects the pair of frames on the nose, and a band 8 that connects the pair of frames 2 at the ears and holds the swimming goggles worn by wrapping around the back of the head.

Since the detailed configuration and structure of the swimming goggles can be achieved by various configurations and structures that are widely known on the market, the detailed description is not provided herein and the present invention is not specifically limited in the configuration and structure of a pair of swimming goggles.

The main body 10 is made of a transparent synthetic resin. For example, poly-carbonate resin, polyacetate resin, or polyethylene terephthalate resin may be individually used, or two or more of them may be bonded to be used.

The main body 10 maintains sufficient strength when having a 0.1-0.8 mm thickness, such that it is possible to maintain a high close-contact property with the lens surface of the see-through window 4 in an attachment process, without generating bubbles.

When the thickness of the main body 10 is too small, appropriate strength cannot be maintained and the attachment becomes difficult. In contrast, when the thickness of the main body 10 is too large, the strength is large and smooth attachment is difficult and the overall transparency is decreased, such that the visible range and visibility are reduced.

The main body 10 is formed in a shape corresponding to the shape of the lens surface of the see-through window 4 of the swimming goggles.

The anti-fog layer 20 is formed on the opposite side to the see-through window 4 of the main body 10.

The anti-fog layer 20 is formed by coating a material (e.g., an anti-fog agent) having an anti-fog function.

The anti-fog layer 20 can be formed such that it is not easily damaged or removed by contact with water or other objects, because a hardening process using infrared rays or ultraviolet rays is performed after applying a material having an anti-fog function. That is, in an exemplary embodiment of the present invention, since the anti-fog layer 20 is formed on the sheet-shaped main body 10, it is possible to perform a post-process for increasing the adhesive force in the hardening process after applying a material having an anti-fog function, such that the anti-fog layer 20 can be provided with sufficient durability.

The anti-fog layer 20 formed as described above sufficiently maintains the anti-fog function for over 30 days when being used one hour a day.

It is preferable to select and use a material having high transparency in order to not reduce the visibility of the anti-fog layer 20. A variety of materials that are commonly used for swimming goggles, windows of vehicles, windows of aircrafts, windows of laboratories, etc., can be used for the material having an anti-fog function for forming the anti-fog layer 20; therefore, a detailed description thereof is not provided.

It is possible to further provide a protection film 60 on the anti-fog layer 20 to prevent the anti-fog layer 20 from being damaged or contaminated in manufacture, transport, and installation.

The protection film 60 is detached and discarded right before the attachment on the see-through window 4 of the swimming goggles 2 or after the attachment is finished.

The adhesive layer 30 is formed on the surface (surface contacting the see-through window 4) facing the see-through window 4 of the main body 10.

The adhesive layer 30 is formed by coating an adhesive material.

In this configuration, it is preferable to use materials (e.g., materials used for post-it, magic tape, scotch tape) that have a small adhesive force and can be easily attached/detached, for the adhesive material forming the adhesive layer 30, because it is thereby possible to prevent the adhesive components from remaining on the lens surface of the see-through window 4 when replacing it.

It is preferable to select and use an adhesive material having high transparency in order to not reduce the visibility of the adhesive layer 30. Materials known in the art can be used for the adhesive material forming the adhesive layer 30; therefore, a detailed description thereof is not provided herein.

The release paper 40 is attached to the surface of the adhesive layer 30 such that it can be easily detached.

The release paper 40 is used to prevent impurities or dust from being attached to the adhesive layer 30 and prevent the transparency from being reduced by fingerprints when touched by a hand.

The release paper 40 is detached and discarded right before the attachment on the see-through window 4 of the swimming goggles.

The grip 50 is formed to integrally protrude from an edge of the main body 10.

The grip 50 can be formed to protrude in a rectangular shape, or may have various shapes, such as triangular, trapezoidal, semicircular, elliptical, petal, heart, clover, and cross shapes.

The grip 50 can be formed at only one position, or may be formed at two to eight positions.

By forming the grip 50 as described above, it is easy to repeatedly attach/detach the main body 10 to/from the see-through window 4 of the swimming goggles. For example, when bubbles remain while the main body 10 is attached to the see-through window 4 of the swimming goggles, the bubbles reduce the visibility and obstruct the view. However, it is very difficult to attach the main body 10 to the see-through window 4 without causing bubbles, at one time; therefore, the main body needs to be attached again to be in close contact with the see-through window without bubbles, after detaching the attached portion when bubbles remain.

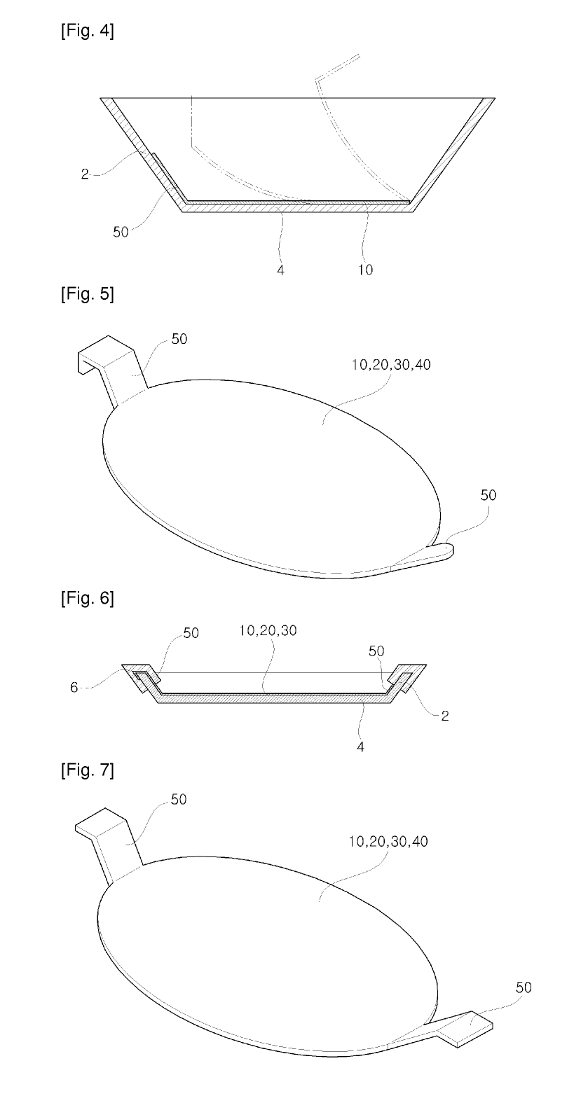

The grip 50, as shown in FIG. 4, may be formed to have a smaller length than the height of the frame 2 of the swimming goggles.

Further, in the second exemplary embodiment of an anti-fog instrument for swimming goggles according to the present invention, the grip 50, as shown in FIG. 5 and FIG. 6, may be formed to have a larger length than the height of the frame 2 of the swimming goggles at one side of the main body 10 to cover the edge of the frame 2, and in a smaller length than the height of the frame of the swimming goggles 2 at the other side.

When the grip 50 is formed long to cover the edge of the frame 2 as described above, the grip 50 is in close contact with the frame 2 by the packing member 6, such that the grip 50 does not come off from the side of the frame 2 and obstruct the view.

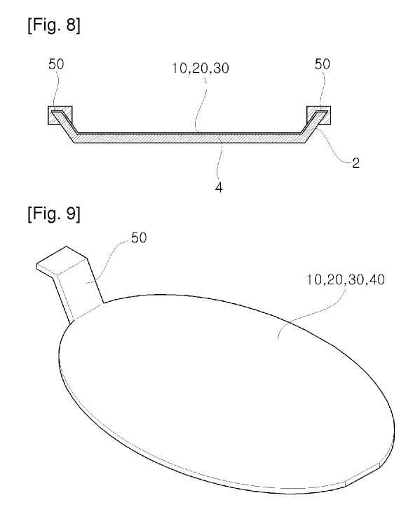

Further, in the third exemplary embodiment of an anti-fog instrument for swimming goggles according to the present invention, as shown in FIG. 7 and FIG. 8, the grip 50 may be formed at both sides of the main body 10 to cover the upper surfaces of the edges of the frames 2 of the swimming goggles.

Further, in the fourth exemplary embodiment of an anti-fog instrument for swimming goggles according to the present invention, as shown in FIG. 9, the grip 50 may be formed only at one side of the main body 10 to cover the upper surface of the edge of the frame 2 of the swimming goggles.

The grip 50 may be achieved by combining the configurations of the first exemplary embodiment to the fourth exemplary embodiment in various ways, and the number is not limited to one to two but may be three to eight.

Although preferred exemplary embodiments of an anti-fog instrument for swimming goggles according to the present invention were described above, it is to be understood that the invention is not limited to the disclosed embodiments, but, on the contrary, is intended to cover various modifications and equivalent arrangements included within the spirit and scope of the appended claims.

1. An anti-fog instrument for swimming goggles, comprising:
a main body that is made of transparent synthetic resin to have a shape corresponding to a see-through window of the swimming goggles;
an anti-fog layer that is formed at the opposite side of the see-through window of the main body, by coating a material having an anti-fog function;
an adhesive layer that is formed at a side facing the see-through window of the main body, by coating an adhesive material;
a release paper that is attached to the surface of the adhesive layer to be easily detached; and
a grip that integrally protrudes from one side of the edge of the main body.

2. The anti-fog instrument for swimming goggles of claim 1, wherein the grip is formed to have a smaller length than the height of the frame of the swimming goggles.

3. The anti-fog instrument for swimming goggles of claim 1, wherein the grip is formed to have a larger length than the height of the frame of the swimming goggles to cover the edge of the frame.

4. The anti-fog instrument for swimming goggles of claim 1, wherein the grip is formed at one to eight positions.

5. The anti-fog instrument for swimming goggles of claim 1, further comprising a protection layer provided on the anti-fog layer to prevent the anti-fog layer from being damaged or contaminated in manufacture, transport, and installation.

6. The anti-fog instrument for swimming goggles of claim 1, wherein the main body is formed to have a thickness of 0.1˜0.8 mm.
